(19) United States
(12) Patent Application Publication
(10) Pub. No.: US 2007/0171952 A1
(43) Pub. Date: Jul. 26, 2007

(54) Excimer laser and line narrowing module

(76) Inventor: Jang-Sun Kim, Hwaseong-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/541,730

(22) Filed: Oct. 3, 2006

(30) Foreign Application Priority Data
Jan. 20, 2006 (KR) 2006-0006081

(51) Int. Cl. H01S 3/22; H01S 3/08

(52) U.S. Cl. 372/57; 372/108; 372/102

(57) ABSTRACT

An excimer laser and a line-narrowing module capable of increasing and maximizing production yield in semiconductor manufacturing are disclosed. The line-narrowing module utilizes a beam expander that passes laser light, produced by and incident from a generator of the excimer laser and collimates the laser light in one direction. A diffraction grating receives the collimated laser light and diffracts the laser light and causes a traveling direction of the laser light to be separated according to an associated wavelength of the laser light. A multi-wavelength reflector located at a reflecting position on one side between the diffraction grating and the beam expander in order to re-enter the laser light having a multi-wavelength into the generator through the beam expander. The multi-wavelength reflector reflects the laser light consisting of a plurality of wavelengths among the laser light whose traveling direction is separated from the diffraction grating onto the beam expander.

### BACKGROUND OF THE INVENTION

1. Technical Field

Embodiments of the invention relate to semiconductor manufacturing equipment, and more particularly, to an excimer laser used as a light source in an exposure apparatus for photosensitizing photoresist formed on a wafer, and a line narrowing module associated therewith.

This application claims the benefit of Korean Patent Application No. 10-2006-0006081, filed Jan. 20, 2006, the disclosure of which is hereby incorporated herein by reference in its entirety.

2. Discussion of Related Art

Currently, with the rapid development of the information telecommunication field and the popularization of information media such as computers, semiconductor equipment is being remarkably developed. The use of semiconductors is required to ensure high-speed operation of these devices, as well as providing mass storage capacity. Thus, technology of fabricating semiconductor devices is developed to maximize integration density, reliability, response speed, etc. of these devices.

The fabrication of semiconductor devices generally includes the steps of deposition, photolithography, etching and implantation. The deposition step forms a processing layer (SiO₂) on a semiconductor substrate or wafer. In the photolithography step, a pattern is imaged onto the substrate, via a mask or reticle, which is at least partially covered by a layer of radiation-sensitive material known as a photoresist. The etching step is used to etch away that portion of the processed layer no longer protected by the photoresist. The ion implantation step is used to implant impurity ions into the substrate. This is done by exposing the surface of the wafer to high energy ions having the desired chemical properties.

In the photolithography process a photosensitive layer of photoresist, formed on the semiconductor substrate in a desired pattern, is used as the mask in the etching or ion implantation process and includes a photoresist coating process, a soft bake process, an edge exposure process, a side rinse process, a hard bake process, an exposure process, and a development process. The photolithography process is performed in a semiconductor manufacturing device called a spinner or an exposure apparatus. The photolithography process is being actively studied and developed because it is important in determining critical dimensions of a semiconductor device during the semiconductor manufacturing process.

The exposure apparatus includes a light source for producing light such as ultraviolet (UV) light or X-ray for photosensitizing the photoresist, a light delivery unit for delivering the light produced from the light source from a predetermined distance, a reticle for transferring the light delivered from the light delivery unit onto a predetermined patterned image, a reduction-projection lens for providing the light transferred through the reticle toward the wafer, and a wafer stage for supporting and aligning a wafer so as to allow the patterned image to be projected on the wafer at a corresponding position.

The light source produces a short wavelength of light that projects the patterned image of the reticle onto the wafer, and thus photosensitizes the photoresist layer. Due to the high-density integration of semiconductor devices, it is desirable to use a short wavelength light source to produce a very focused beam when patterning the image on the wafer. In addition, a light source that produces short wavelength light has low chromatic aberration through a reduction-projection lens when applied to the wafer as well as minimizing diffraction or interference of the light when passing through the patterned image of the reticle; Chromatic aberration is caused by a lens having a different refractive index for different wavelengths of light.

The light employed to a typical exposure apparatus may include an arc mercury lamp line spectrum such as a g-line (436 nm) or an i-line (365 nm) emitted from an arc mercury lamp, light emitted from a KrF (248 nm) or ArF (193 nm) excimer laser, and so on. The arc mercury lamp line spectrum has been mainly used in the process of fabricating semiconductor memory devices having a capacity between 4 Mbyte and 6 Mbyte, and the excimer laser light has been mainly used in the process of fabricating semiconductor memory devices having a capacity of 64 Mbyte or more. The excimer laser produces a brief, but intense pulse of UV light used for semiconductor manufacturing because the short wavelength of light can write very fine lines associated with circuits.

The excimer laser producing this excimer laser light includes a generator designed to apply high voltage having a predetermined oscillating frequency to a gas mixture with which a laser chamber is filled. The application of voltage to the chamber excites the gas mixture wherein the mixture consists of a halogen gas such as fluorine (F), an inert gas such as a krypton (Kr) or argon (Ar), and a neon (Ne) gas used as a buffer gas. The generator makes it possible to produce the excimer laser light while the excited gas mixture transitions to a stable state. Hereinafter, the light produced from the light source such as the excimer laser is referred to as the excimer laser light. Excimer lasers are used in manufacturing semiconductors because they produce a brief, but intense pulse of UV light where the short wavelength of light can write very fine lines associated with circuit elements.

In a typical exposure apparatus which employs an excimer laser, the light projected onto the photoresist coated on the wafer through the patterned image of the reticle and the reduction-projection lens has a resolution (R) and a depth of focus (DOF) expressed by the following equations:

R=k1·λ/NA Equation (1)

DOF=k2·λ/(NA)2 Equation (2)

where k1 and k2 are constants representing the reflecting properties of the photoresist and the exposure process respectively; λ is the wavelength of the excimer laser light that is produced from the light source and incident onto the photoresist; and NA is the numerical aperture of the reduction-projection lens. The constants, k1 and k2, can be controlled by improving a chemical property of the photoresist and the NA can be controlled by adjusting the medium and aperture of the reduction-projection lens. Resolution, R, should be decreased to downsize the semiconductor device and the DOF should be increased so that the patterned image is clearly produced on a front or rear surface of the photoresist formed on the wafer.

The resolution can be decreased by shortening the wavelength λ of the excimer laser light produced from the light source as shown by Equation 1. However, the shorter the wavelength of the excimer laser light, the lower the DOF on the photoresist through the reduction-projection lens as shown by Equation 2. In this manner, when the wavelength of the excimer laser light is shortened, the DOF decreases which increases the influence of chromatic aberration. For this reason, the excimer laser light should be produced so as to have a more precise line width capable of overcoming chromatic aberration associated with the reduction-projection lens. In other words, the excimer laser light emitted from the excimer laser used as the light source for the exposure apparatus should be split and line-narrowed so as to have a more precise line width.

One example of a method for splitting and line-narrowing excimer laser light is based on the use of a grazing incidence grating, a diffraction grating with a beam expander, a prism, an etalon (or Fabry-Pérot interferometer), and combinations thereof. In this type of line-narrowing method it is possible to obtain line-narrowed excimer laser light using a line-narrowing module (LNM) that generally has a beam expander and a diffraction grating. The excimer laser light, which enters through a window formed on one side of the generator, is collimated at the beam expander. The light is diffracted and split by the diffraction grating. The grating selectively reflects only the excimer laser light having a single wavelength onto the beam expander and emits the single wavelength light through another window formed on the other side of the generator. Thus, when excimer laser light produced by a generator having various wavelengths enters a conventional LNM, the light is diffracted and split into various wavelengths. The LNM selectively reflects only a single wavelength of excimer laser light back into the generator chamber and supplies it to the exposure apparatus. However, as semiconductor device elements exposed and patterned by an exposure apparatus are gradually downsized, the single wavelength of excimer laser light focused onto the photoresist of the wafer through a reduction-projection lens has a decreased DOF. When the DOF is lowered, exposure failure may occur leading to lower production yields.

### SUMMARY OF THE INVENTION

Therefore, the present invention provides an excimer laser and LNM in which the DOF and margin of excimer laser light focused on a layer of photoresist of a wafer via a reduction-projection lens of an exposure apparatus is increased to avoid exposure failure, thereby increasing and maximizing production yields.

According to an aspect of the present invention, a LNM associated with an excimer laser comprises a beam expander that passes laser light produced by and incident from a generator of the excimer laser and collimates the laser light in one direction. A diffraction grating diffracts the collimated laser light from the beam expander and causes the traveling direction of the laser light to be separated according to its respective wavelengths. A multi-wavelength reflector, disposed between the diffraction grating and the beam expander, reflects the multi-wavelength laser light consisting of at least two wavelengths from the diffraction grating back into the generator through the beam expander.

One embodiment of the multi-wavelength reflector in accordance with the present invention may include a mirror and a vibrator. The mirror reflects the multi-wavelength laser light onto the beam expander. The vibrator is used to vibrate one side of the mirror in order to collect the laser light having a plurality of single wavelengths and different traveling directions. The vibrator may include a piezo actuator which vibrates one side of the mirror at a frequency higher than an oscillating frequency supplied to the generator of the excimer laser.

According to another aspect of the present invention, an excimer laser is provided which comprises a generator that excites a light emitting material to produce laser light. A LNM having a beam expander that passes the laser light, produced by and incident from the generator, collimates the laser light in one direction. A diffraction grating diffracts the collimated laser light received from the beam expander and causes the traveling direction of the laser light to be separated according to its associated wavelength. A multi-wavelength reflector is located between the diffraction grating and the beam expander and reflects the laser light having at least a different plurality of single wavelengths onto the beam expander in order to re-enter the multi-wavelength laser light into the generator through the beam expander. An output coupler module (OCM) is located on the other side of the generator opposite the LNM. The OCM supplies the laser light, having the different plurality of single wavelengths, to the generator which is then emitted from the generator externally.

### BRIEF DESCRIPTION OF THE DRAWINGS

FIG. 1 is a diagram illustrating an excimer laser according to an exemplary embodiment of the present invention;

FIGS. 2 and 3 are diagrams illustrating the generator of FIG. 1;

FIG. 4 is a graph plotting change of output energy according to a change of concentration of fluorine supplied into the laser chamber of FIG. 2;

FIG. 5 is a graph plotting change of output energy according to change of the pressure of a mixture gas supplied into the laser chamber of FIG. 2;

FIG. 6 is a detailed diagram illustrating the line-narrowing module of FIG. 1;

FIG. 7 is sectional view illustrating the reflection diffraction grating of FIG. 6; and

FIG. 8 is a schematic diagram illustrating an exposure apparatus to which an excimer laser according to an exemplary embodiment of the present invention is employed.

### DESCRIPTION OF EMBODIMENTS

The present invention will now be described with reference to the accompanying drawings in which exemplary embodiments of the invention are illustrated. This invention, however, may be embodied in many different forms and should not be construed as being limited to the embodiments set forth herein. Rather, these embodiments are provided so that this disclosure will be thorough and complete, and will fully convey the scope of the invention to those skilled in the art.

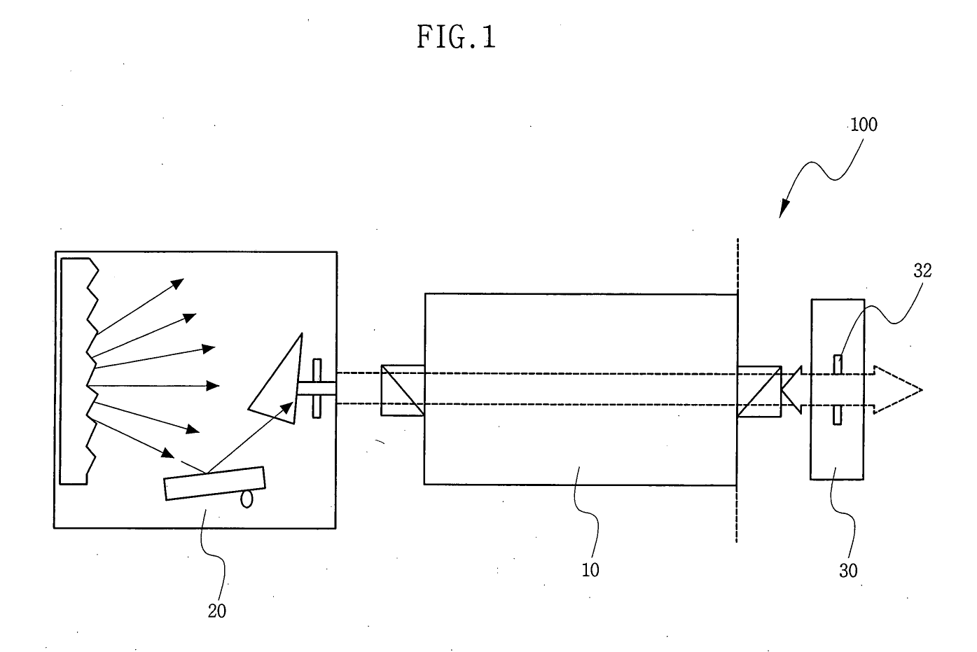

FIG. 1 is a diagram illustrating an excimer laser 100 according to an exemplary embodiment of the present invention. An excimer laser 100 is composed of a generator 10, a line narrowing module 20, and an output coupler 30. Generator 10 is used for exciting a light emitting material such as a halogen or inert gas to produce excimer laser light. The line-narrowing module (LNM) 20 communicates with generator 10 and is used to line-narrow the excimer laser light produced by generator 10 and feeds back the laser light having at least two wavelengths to generator 10. Output coupler module (OCM) 30, disposed on the opposite side of generator 10 from LNM 20, outputs the excimer laser light fed back to generator 10 by line-narrowing module 20 to the light delivery unit of an exposure apparatus or externally from excimer laser 100

Generator 10 applies a predetermined energy to the light emitting material such as the halogen or inert gas which deprives a valence electron of each atom of the light emitting material. This excites the light emitting material and produces the excimer laser light having a predetermined wavelength while an excited molecule, called an excimer formed by conversion of each atom having a ground state (i.e. a stable state) into each atom having an excited state (i.e. an unstable state), emits light when it returns to a dissociated state. In particular, light or an electric field having a predetermined energy is applied to the light emitting material within generator 10 where a valence electron is deprived of each atom of the light emitting material. The atoms are converted from a stable state to an unstable state. Thereafter, when the light or electric field is removed, the atoms having the unstable state are bonded with the atoms having the stable state and the valence electron is taken back. The bonded atoms are maintained in at least one meta stable state which is a state between the stable state and the unstable state for a predetermined time without immediately returning back to the stable state, and then transitioned from the meta stable state to the stable state. During this transition, a constant wavelength of excimer laser light is emitted. When the atoms having the unstable state converted from the atoms having the stable state are bonded with each other, an extremely unstable compound is formed called an excited dimmer. At this time, several meta stable states can exist within a similar range between the stable state and the unstable state. Light emitting material, for example mercury, fluorine, krypton, argon, helium, etc., may be used. The light produced according to an energy level of each light emitting material can be sorted into g-line (436 nm), i-line (365 nm), KrF excimer laser light (248 nm), ArF excimer laser light (193 nm), fluoride dimmer light (157 nm), extreme ultraviolet (EUV) light (13 nm),etc. In this manner, generator 10 can be used according to various techniques to produce excimer laser light. The generator 10 for producing the excimer laser light may be constructed as follows.

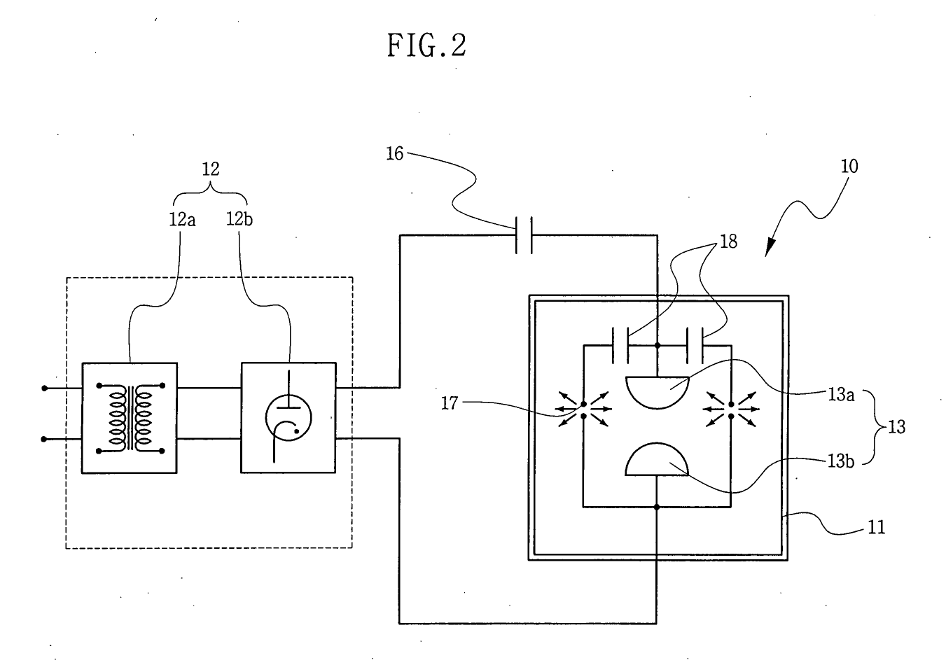

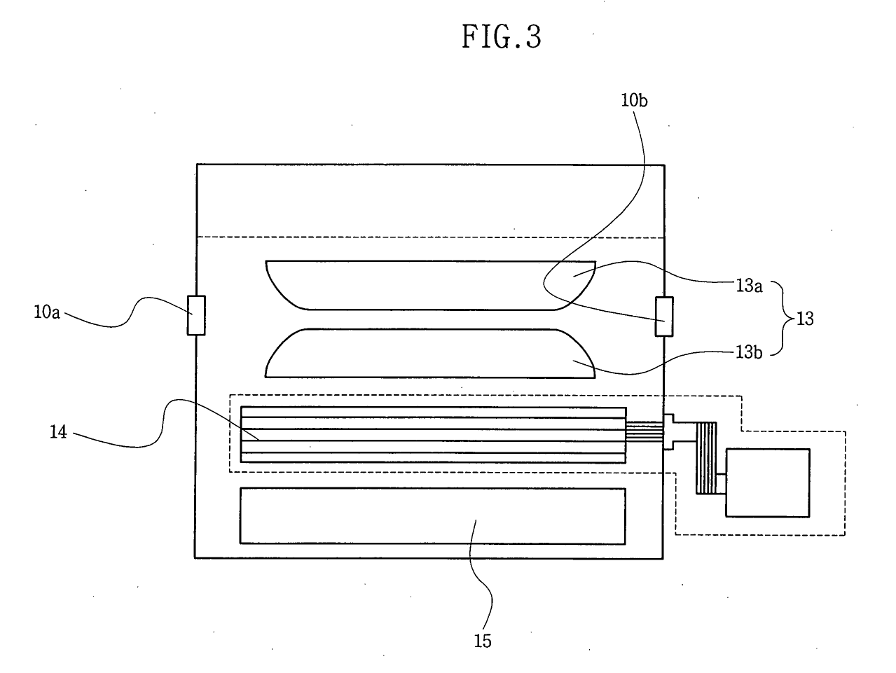

FIGS. 2 and 3 are diagrams illustrating the generator 10 of FIG. 1 for producing excimer laser light. Generator 10 is composed of a laser chamber 11 filled with at least one light emitting material. A voltage supply 12, configured externally of chamber 11, provides a supply voltage having a predetermined oscillating frequency to at least one pair of main electrodes 13 formed at upper and lower ends of laser chamber 11. Electrodes 13 are positioned a predetermined distance apart in order to activate the light emitting material inside laser chamber 11. A fan 14 is used to circulate the light emitting material between the main electrodes 13 at a constant flow rate. A heat exchanger 15 is positioned below fan 14 and is used to absorb and cool heat generated by the light emitting material in chamber 11. A storage capacitor 16 is disposed between the voltage supply 12 and at least one of the main electrodes 13. A plurality of arc pins 17 is disposed around main electrodes 13 and configured to induce electric discharge in the proximity of main electrodes 13 in order to preliminarily ionize ultraviolet (UV) light from the light emitting material in chamber 11. A pair of peaking capacitors 18 is provided between arc pins 17 and storage capacitor 16 in order to amplify the supply voltage that is charged or discharged by storage capacitor 16.

Laser chamber 11 includes a plurality of windows through which the excimer laser light generated between main electrodes 13 is emitted from the chamber. A plurality of windows 10a and 10b are opposedly positioned with a plurality of ports formed through sidewalls of laser chamber 11. For example, the plurality of ports may have a diameter of about 50 mm and the plurality of windows associated with each of the plurality of ports may be formed of CaF2. First window 10a is formed on a sidewall of chamber 11 adjacent to the line-narrowing module 20 and is adapted to pass all the excimer laser light of various wavelengths generated inside chamber 11 to LNM 20. Second window 10b is formed on a sidewall of chamber 11 adjacent to OCM 30 and is adapted to reflect excimer laser light of various wavelengths generated inside chamber 11 back to first window 10a, and to pass to OCM 30 only specific excimer laser light of at least one single wavelength split and extracted by LNM 20.

Voltage supply 12 produces high voltage to electrify the light emitting material with which the laser chamber 11 is filled. For example, supply voltage 12 produces a high-voltage direct current between about 2,000 V and about 5,000 V, and applies it to electrodes 13. Voltage supply 12 includes a pulse transformer 12a for transforming the high voltage into high voltage having a predetermined frequency. Switch 12b provides the high voltages at a predetermined oscillating frequency so that the excimer laser light is repeatedly emitted from the light emitting material flowing between the electrodes 13 while the predetermined frequency of the high voltage produced by the pulse transformer 12a is charged or discharged in/from storage capacitor 16. Switch 12b may be, for example, a spark gap, a discharge tube such as a thyratron, a magnetic pulse compression circuit such as a magnetic switch, a semiconductor device such as a thyristor (or a semiconductor controlled rectifier (SCR)), etc. The oscillating frequency of the high voltage from switch 12b may be, for example, within the range of about 2 KHz to about 3 KHz. If a rise time of the current is set to about 7 nsec using a thyratron switch, and a peak operating voltage is set to about 32 KV, a sufficiently stable operation of the light emitting material can be ensured at a maximum number of switching operations of about 2 KHz.

The pair of main electrodes 13 can electrify and spark-discharge the light emitting material by applying an electric field to the light emitting material flowing in the region between the main electrodes. Main electrodes 13 may be formed, for example, with an Ernst profile so as to oppose each other where a cathode electrode 13b has a width greater than an anode electrode 13a. For example main electrodes 13 may have a width of about 30 mm and a length of about 640 mm. Because negative charges are prevented from being concentrated on corners of the cathode electrode 13b, the light emitting material can be uniformly discharged. When the region between main electrodes 13 is set to about 20 mm, a discharge effective volume of the main electrodes 13 can become about 96 cm³.

Fan 14 acts as a blower for circulating the light emitting material filled in laser chamber 11 at a predetermined pressure using the rotating force of motor 14a which rotates outside laser chamber 11 at a predetermined speed. In this manner, fan 14 allows excimer laser light to be repeatedly produced at a constant intensity by causing the light emitting material, cooled by heat exchanger 15, to flow between main electrodes 13 at a constant flow rate. In addition, fan 14 allows the light emitting material overheated between main electrodes 13 to be cooled when flowing toward heat exchanger 15. When the light emitting material overheats during laser light production as the supply voltage is applied between main electrodes 13, heat exchanger 15 cools this light emitting material up to a predetermined temperature. To this end, heat exchanger 15 includes a cooling plate (not shown) for cooling the light emitting material by depriving the heat of the light emitting material while the light emitting material flows at a predetermined flow rate. The cooling plate can be maintained at room temperature by cooling water supplied externally.

Storage capacitor 16 charges or discharges the high voltage supplied from voltage supply 12 by means of switch 12b via a switching operation, thereby allowing the high voltage to be momentarily applied to main electrodes 13. Storage capacitor 16 may have, for example, capacitance of about 90 nF or more so as to accommodate charges induced by the high voltage.

Arc pins 17 induce electric discharge when the charge of storage capacitor 16 moves to peaking capacitors 18. For example, each of arc pins 17 may have a needle shape in order to provide a plurality of contacts spaced apart by a predetermined distance so that discharge efficiency can be maximized. In an illustrated embodiment, about 15 pairs of arc pins 17 may be arranged around main electrodes 13 at intervals of about 20 mm. Peaking capacitors 18 may be configured externally from laser chamber 11 or they may be mounted within laser chamber 11 to minimize inductance induced from discharging by main electrodes 13. Peaking capacitors 18 may have, for example, capacitance of about 60 nF or more. Peaking capacitors 18 can be designed to cause stored charge in storage capacitor 16 to move to peaking capacitors 18 within a relatively short time (pulse rise time) during discharging. Voltage supply 12, storage capacitor 16, and main electrodes 13 define a main discharge circuit where the associated inductance can be calculated by a single turn solenoid equation. Peaking capacitors 18 are installed on the opposite side of chamber 11 from fan 14 and heat exchanger 15 so as not to hinder circulation of the light emitting material.

Although not shown in FIG. 3, a supply source may be employed for supplying light emitting material filled in laser chamber 11. This supply source may be coupled to laser chamber 11. As mentioned above, the light emitting material may contain, for example, fluorine (F) as an exemplary halogen element, and an inert gas for buffering reaction of the halogen element such as helium (He), krypton (Kr), argon (Ar), etc. Because there are various meta stable states associated with the halogen gas and the various types of inert gases, various wavelengths of excimer laser light may be produced in chamber 11. For example, in the case of a KrF excimer laser in which fluorine (F), krypton (Kr), and helium (He) are mixed as the light emitting material, laser light having a wavelength between about 248.2 nm and about 248.8 nm can be produced. The output energy of excimer laser 100 can be varied according to: (1) the concentration of the halogen gas contained in the light emitting material supplied in laser chamber 11; and/or (2) the density of the mixture containing the halogen gas in an associated amount.

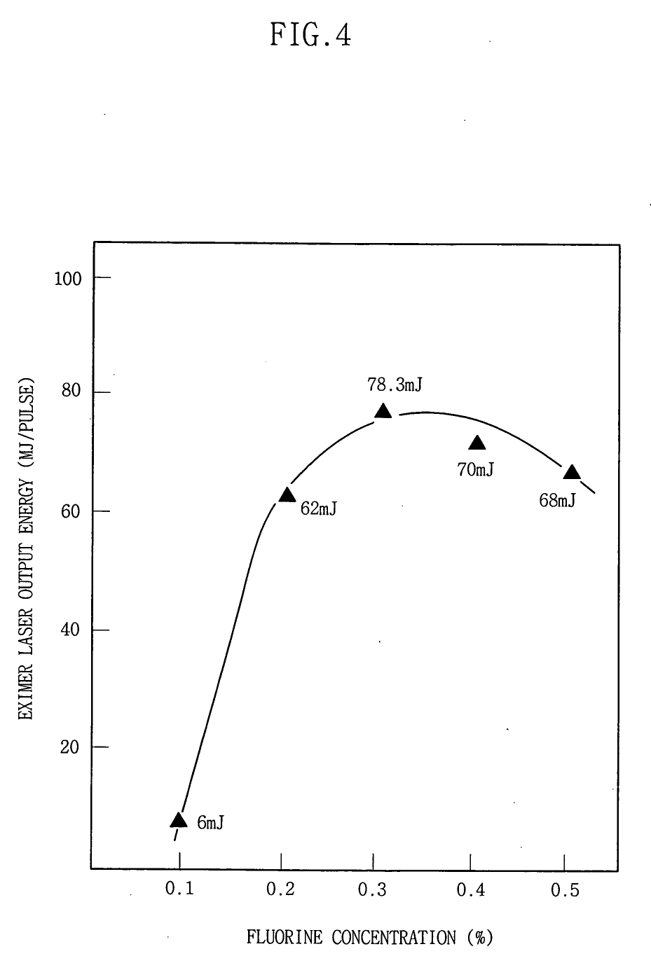

FIG. 4 is a graph plotting the change of output energy according to a change in the concentration of fluorine supplied to laser chamber 11 based on an exemplary test using argon as the inert gas mixed with fluorine under a pressure of about 2.5 atm. The abscissa represents the percentage of fluorine concentration and the ordinate represents the output energy of the excimer laser light. The graph shows that as the concentration of fluorine in the light emitting material supplied into laser chamber 11 increases, the output energy of the excimer laser light produced increases up to a predetermined level and decreases thereafter. In particular, the output energy increased to a maximum value of 78.3 mJ at a 0.3% concentration of fluorine and started to decrease when the concentration of fluorine exceeded 0.3%. In the subject ArF excimer laser, it could be found that because the fluorine molecules were excessively supplied into laser chamber 11 which bonded with excited fluorine atoms, the output energy decreased. Further, the fluorine molecules excessively supplied into laser chamber 11 caused non-uniform discharging between main electrodes 13 which decreased the output energy of the excimer laser light. Because an energy level of the meta stable state of the mixture gas could be varied depending on the argon and helium components mixed with the fluorine component, the excimer laser light having various wavelengths could be produced. The output energy of the laser increased in direct proportion to the concentration of a halogen gas, such as fluorine, supplied into laser chamber 11, but decreased when the halogen gas exceeded a predetermined concentration. In this manner, generator 10 of excimer laser 100 according to the present invention can produce various wavelengths of excimer laser light.

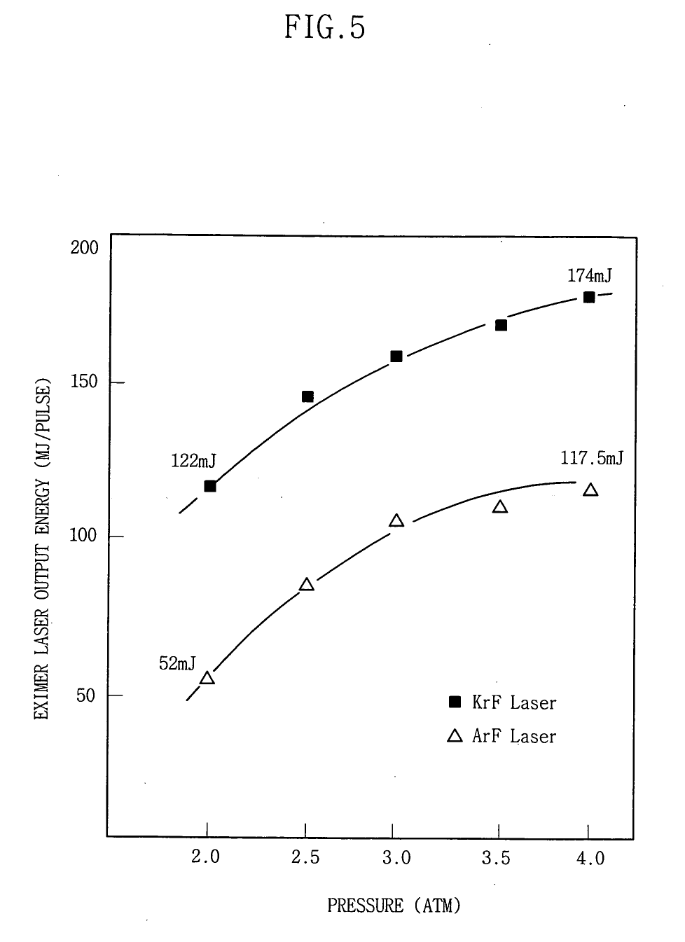

FIG. 5 is a graph plotting the change of output energy according to the change in pressure of a gas mixture supplied into laser chamber 11. Here, the abscissa represents the pressure of the gas mixture and the ordinate represents the output energy of the excimer laser light. The graph shows that as the pressure of the gas mixture supplied into laser chamber 11 increases, the output energy of the excimer laser light produced inside laser chamber 11 increases in proportion to the pressure. A fraction of the gas mixture for producing light from the KrF excimer laser is given as: F2/Kr/He=0.2/3/96.8(%), while a fraction of the gas mixture for producing light from the ArF excimer laser is given as: F2/Ar/He=0.3/6/93.7(%). Thus, the generator 10 of the excimer laser 100 in accordance with the present invention produces excimer laser light having various wavelengths while the output energy increases as the pressure of the gas mixture in which the halogen and inert gases supplied into laser chamber 11 are mixed. In particular, the output energy reached a maximum value of 117.5 mJ/pulse when the pressure was about 4.0 atm, and was saturated when the pressure exceeded 4.0 atm. When the KrF excimer laser light was oscillated under the same condition, the output energy had a maximum value of about 174 mJ/pulse. Thus, the output energy of the KrF laser light was 48% greater than the energy of the ArF exicmer laser light. Because the output energy of the ArF excimer laser light was low under the same or similar pressure compared with that of the KrF excimer laser light, it could be found that the KrF excimer laser light was higher in efficiency. It was found that the energy of the excimer laser light is determined according to the magnitude of the ionized energy of the light emitting material and thus, increased in proportion to the magnitude of the supply voltage supplied from voltage supply 12.

The excimer laser light produced inside laser chamber 11 has a greater spatial distribution characteristic in the Y-axis along a lateral direction of main electrodes 13 as compared with the X-axis of a longitudinal direction parallel to main electrodes 13. For example, excimer laser light has a spatial distribution characteristic that is emitted into the space between the main electrodes of about 3 mrad (about 0.17°) in the X-axis direction and about 5 mrad (about 0.29°) in the Y-axis direction from the center of the space between main electrodes 13. The excimer laser light having the X-axial spatial distribution characteristic has a Gaussian distribution in which its intensity is the highest in a direction parallel to the center of the space between main electrodes 13, while the excimer laser light having the Y-axial spatial distribution characteristic has a “cave-in” type distribution where its intensity is the highest at a position adjacent to surfaces of main electrodes 13. The intensity is at its lowest at the center of the space between the main electrodes 13. Thus, generator 10 can be designed such that the excimer laser light having the spatial distribution characteristic of the Gaussian distribution having a peak at the center between main electrodes 13 and parallel to main electrodes 13 disposed within laser chamber 11 is emitted to first and second windows 10a and 10b of laser chamber 11.

Accordingly, generator 10 of excimer laser 100 applies the supply voltage having a predetermined oscillating frequency to the light emitting material having a stable state energy level and converts the valence electron of each atom of the light emitting material from the ground state to the excited state. Excimer laser light having at least one wavelength corresponding to the energy level of the meta stable state is produced while the valence electron is on standby in at least one meta stable state and then transited from the meta stable state to the stable state. The LNM 20 acts as an optical resonator. In particular, when the excimer laser light produced by generator 10 enters through first window 10a, LNM 20 selectively splits and extracts only a specific excimer laser light having at least one wavelength and feeds the extracted excimer laser light back to generator 10 through window 10a.

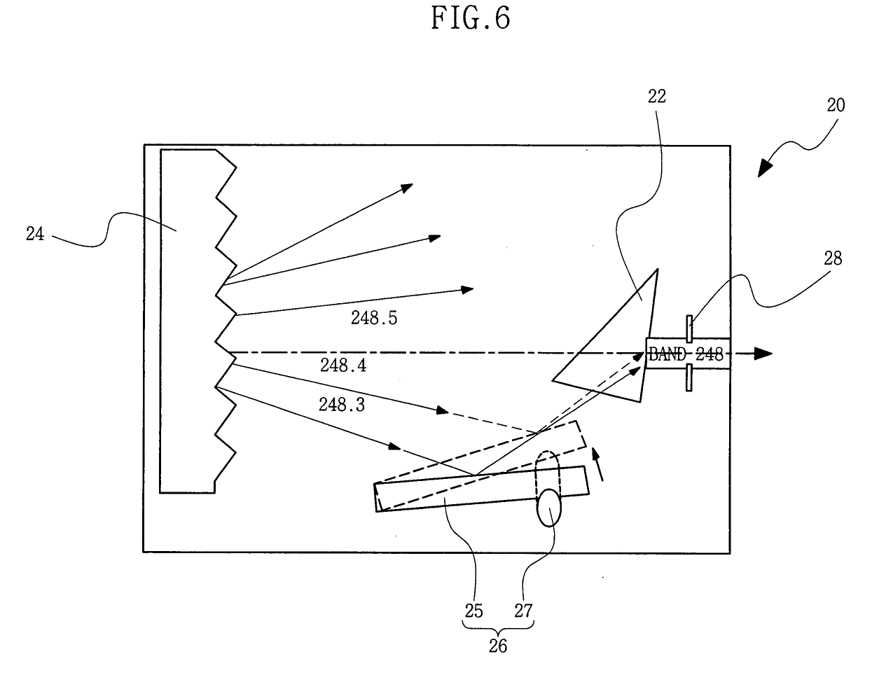

FIG. 6 illustrates the LNM 20 of FIG. 1 comprising beam expander 20, a reflection diffraction grating 24, and a multi-wavelength reflector 26. Beam expander 22 is configured to pass excimer laser light produced by generator 10 received through first window 10a and collimates the light in one direction. Reflection diffraction grating 24 diffracts the excimer laser light collimated from beam expander 22 and causes the traveling direction of the excimer laser light to be separated according to its corresponding wavelength. Multi-wavelength reflector 26 is disposed at a reflecting position between beam expander 22 and reflection diffraction grating 24 toward one side of LNM 20. The phrase “disposed at a reflecting position between” in this context refers to placement between beam expander 22 and diffraction grating 24, but not necessarily along a central longitudinal or latitudinal axis between such components. Multi-wavelength reflector reflects excimer laser light having a different plurality of single wavelengths among the excimer laser light separated by the reflection diffraction grating 24 onto beam expander 22 and causes the excimer laser light having the different plurality of single wavelengths to re-enter generator 10 through beam expander 22.

Beam expander 22 expands a cross section of the excimer laser light incident through first window 10a of generator 10 in a horizontal direction. A first slit 28 is formed with a first aperture defining the cross section of the excimer laser light so that the excimer laser light incident onto the beam expander 22 and having a predetermined cross section is passed through first window 10a. Beam expander 22 transmits the excimer laser light that passes through the first window 10a and expands the excimer laser light in one or every direction. Beam expander 22 forms a medium through which the excimer laser light is transmitted so as to have a predetermined slope in one direction to allow the excimer laser light to be expanded in the direction in which the medium is slanted. Expander 22 is formed as a concave lens in which the excimer laser light is expanded about the center of the transmitted medium in the direction of a concentric circle. In this manner, the excimer laser light diverges from the center of the transmitted medium in a circular shape. The medium transmitting the excimer laser light has a constant refractive index and can collect the excimer laser light having a different plurality of single wavelengths reflected from the multi-wavelength reflector 26 and feeds back the collected excimer laser light to generator 10 through the first aperture and the first window 10a. The excimer laser light having a different plurality of single wavelengths is reflected from multi-wavelength reflector 26 onto beam expander 22. Because this light has a cross-section far greater than the diameter of the first aperture or the first window 10a, beam expander 22 reduces the cross-section of this light having the different plurality of single wavelengths. Reflection diffraction grating 24 reflects the excimer laser light of various wavelengths which is expanded by and incident from the beam expander 22, and thereby splits the excimer laser light according to its associated wavelength. Reflection diffraction grating 24 diffracts the excimer laser light and may include, for example, an Echelete or Littrow grating.

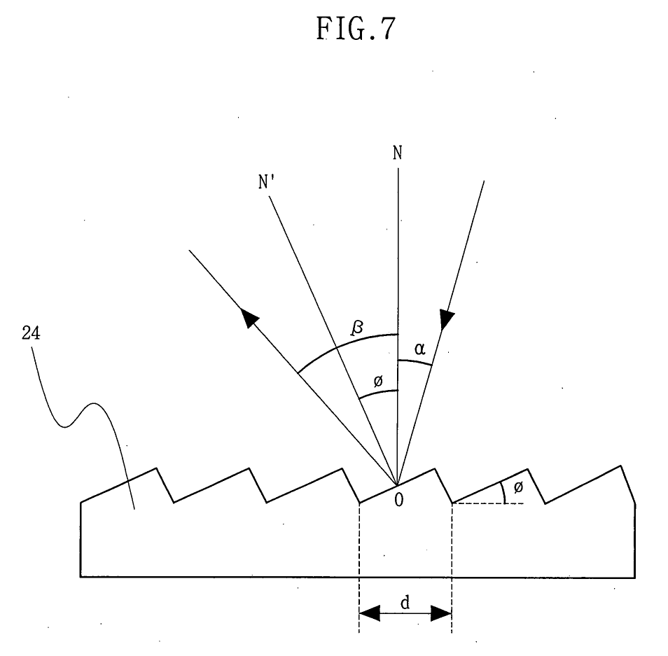

FIG. 7 illustrates reflection diffraction grating 24 shown in FIG. 6 and the light incident thereon. Excimer laser light incident onto reflection diffraction grating 24 at an angle of α (incidence angle) is diffracted and reflected at an angle of β (diffraction angle). Here, the diffraction angle D varies according to the wavelength of the excimer laser light so that the excimer laser light can be split. The line from O to N (ON) represents the grating normal line and the line from O to N′ (ON′) represents the blaze normal line. Angles α and β represent the incidence angle and the diffraction angle, respectively, of the line ON of reflection diffraction grating 24. The grating constant of the reflection diffraction grating 24 is d and φ is the slant angle. When α=β, the excimer laser light having a specific wavelength can be reflected back in an incident direction. Further, when α=φ, mirror reflection takes place and the excimer laser light having a specific wavelength can be collected in one direction.

The excimer laser light travels on a surface of reflection diffraction grating 24 according to the reflective law of nλ=d(sin α+sin β), where n is an integer and the light is incident onto multi-wavelength reflector 26 with a different plurality of single wavelengths. Reflection diffraction grating 24 is configured to diffract the excimer laser light of various wavelengths which are expanded by and incident from beam expander 22 and splits the excimer laser light by varying the diffraction angle β according to a wavelength associated with the laser light. The multi-wavelength reflector 26 reflects the excimer laser light incident thereon from grating 24 which causes the reflected excimer laser light to be laterally incident onto beam expander 22.

Multi-wavelength reflector 26 comprises a mirror 25 that reflects the excimer laser light incident thereon from reflection diffraction grating 24 and a vibrator 27 which supports one side of mirror 25 such that mirror 25 may be slanted at a predetermined angle and vibrated at a predetermined frequency. By slanting the angle of mirror 25, the reflective angle may be varied at predetermined time intervals. Mirror 25 may have a size greater than the cross section of the excimer laser light incident thereon from reflection diffraction grating 24. Vibrator 27 may comprise a piezo actuator having a piezoelectric element configured to vibrate mirror 25 at a frequency higher than the oscillating frequency used to produce the excimer laser light.

The amplitude of mirror 25 is closely related to its reflective angle and corresponds to the height adjustment for supporting one side of the mirror such that the excimer laser light having the different plurality of single wavelengths is reflected. In a KrF excimer laser, for example, the excimer laser light having the different plurality of single wavelengths of 248.2 nm, 248.3 nm, and 248.4 nm is split by reflection diffraction grating 24 and is incident onto mirror 25 which reflects the light having the different plurality of single wavelengths onto beam expander 22 by vibrating the vibrator 27. Accordingly, multi-wavelength reflector 26 reflects the excimer laser light having a different plurality of single wavelengths onto beam expander 22 by use of mirror 25 and vibrator 27 in order to vary the reflective angle of mirror 25 at predetermined time intervals. The excimer laser light having a different plurality of single wavelengths reflected by multi-wavelength reflector 26 is collected onto beam expander 22 and fed back to generator 10 through first window 10a. The beam expander 22 sets the optical path of the excimer laser light having the different plurality of single wavelengths in the direction of first window 10a.

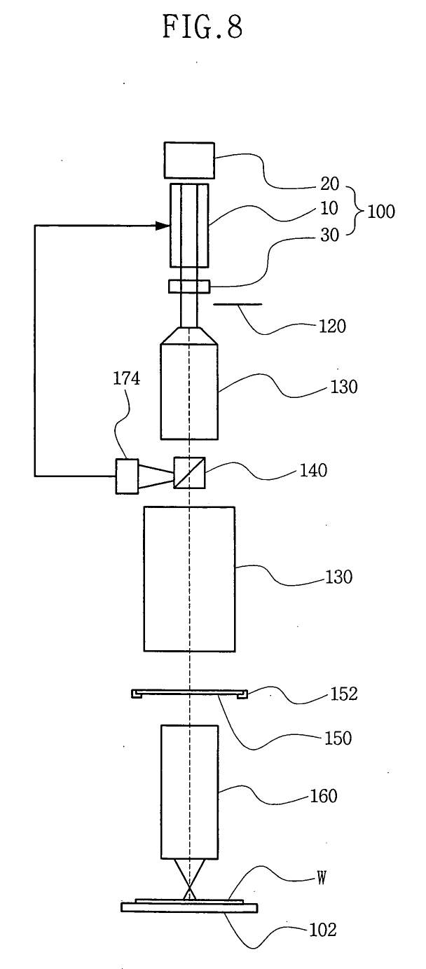

In this manner, LNM 20 of the excimer laser 100 according to an exemplary embodiment of the present invention supplies excimer laser light having a plurality of single wavelengths to an exposure apparatus (shown in FIG. 8), and prevents a failure in exposure by increasing a depth of focus of the excimer laser light having a plurality of single wavelengths to avoid exposure failure and maximize production yield.

Referring back to FIGS. 1 and 3 briefly, the excimer laser light having a different plurality of single wavelengths which is fed back to generator 10 is emitted to output coupler module (OCM) 30 through second window 10b (oppositely arranged from first window 10a) of generator 10. The second window 10b includes a partial reflector for selectively passing only the excimer laser light having a different plurality of single wavelengths emitted through generator 10, and reflecting the excimer laser light having a different plurality of single wavelengths produced and emitted from generator 10 onto first window 10a. The partial reflector included in second window 10b may have, for example, a reflective efficiency of about 20%. OCM 30 further includes a second slit 32 having a second aperture defining a cross section of the excimer laser light emitted through the second window 10b of generator 10. OCM 30 further comprises a wavelength detector (not shown) and a wavelength controller (not shown). Wavelength detector is used to detect the different plurality of single wavelengths of excimer laser light traveling through the second aperture. The wavelength controller is used to feed back a signal detected by the wavelength detector to LNM 20. LNM 20 receives this signal and based thereon, selects excimer laser light having a corresponding one of the different plurality of single wavelengths. OCM 30 is also configured to provide the excimer laser light having the different plurality of single wavelengths to an external optical fiber or a light delivery unit associated with an exposure apparatus. Thus, the functioning of LNM 20 and OCM 30 in combination with generator 10 as described above can be called a resonator for resonating the excimer laser light having a different plurality of single wavelengths produced from generator 10.

FIG. 8 is a schematic diagram illustrating an exposure apparatus to which the excimer laser 100 described above in accordance with an exemplary embodiment of the present invention is employed. An exposure apparatus comprises excimer laser 100 as a light source for producing excimer laser light, a light delivery unit 130 for delivering the excimer laser light produced by the excimer laser 100 without loss, a reticle 150 for transferring the excimer laser light delivered from the light delivery unit 130 to a predetermined patterned image, a reduction-projection lens 160 for reducing and projecting the excimer laser light transferred to the patterned image at reticle 150, and a wafer stage 102 for positioning a wafer W coated with photoresist for exposure to the excimer laser light from reduction-projection lens 160.

Light delivery unit 130 comprises a shutter 120 for screening the excimer laser light produced from excimer laser 100. When an exposure process is initiated, shutter 120 is opened to allow the excimer laser light to be transferred to the patterned image of reticle 150 and then incident onto wafer W. When shutter 120 is closed, for example when the exposure process is completed, excimer laser light is not incident onto wafer W. Light delivery unit 130 may further comprise an optical system including an optic tube, a convex lens, a concave lens, a mirror, etc., in order to deliver the excimer laser light to reticle 150 which is spaced apart from excimer laser 100 by a predetermined distance. For example, the space between reticle 150 and laser 100 may be filled with a material such as quartz or glass and designed such that the light is delivered from excimer laser 100 to reticle 150 without a loss. If necessary, a plurality of optical systems 130 may be employed to deliver the laser light to reticle 150. For ease of reference herein, the optical system 130 has been given the same reference number regardless of the number of systems 130 disposed between excimer laser 100 and wafer W.

Because the excimer laser light diverges into a predetermined space while passing through optical system 130, an illumination assembly (not shown) may be disposed between shutter 120 and optical system 130. The illumination assembly diffracts the light produced from light source 100 using an imaging principle of zero-ordered, first-ordered diffraction light, and selectively extracts the highly directional light from the diffracted light. The illumination assembly is classified into two portions: (1) a conventional illumination system in which the light produced from light source 100 is incident symmetrically about its axis; and (2) an off-axis illumination system in which the light produced from light source 100 is incident asymmetrically about its axis. Generally, the off-axis illumination system can increase the resolution and the DOF as compared to the conventional illumination system. The off-axis illumination system may include three types of apertures, for example, an annular aperture, a dipole aperture, and a quadruple aperture depending on the number of apertures formed symmetrically about the axis of light. Because the excimer laser light that is split from the diffraction light by the illumination assembly has an increased directionality, the light intensity may be lost over the initial period in which it is supplied from laser 100. A beam splitter 140 is disposed between the plurality of optical systems 130 and reticle 150 to check the intensity of light delivered to reticle 150. Beam splitter 140 extracts part of the excimer laser light and supplies it to an optical sensor 174 which generates a sensing signal based on the intensity of the extracted light and supplies it to an exposure controller (not shown). The exposure controller receives the sensing signal and determines the intensity of the excimer laser light to be produced from laser 100.

Reticle 150 is formed with a predetermined patterned image to be transferred onto wafer W using the excimer laser light delivered from the light delivery unit 130. Reticle 150 is supported by reticle stage 152 which is positioned parallel to, but a distance from wafer stage 102. Reticle stage 152 may fixedly support reticle 150 or may move horizontally in a direction parallel to wafer stage 102. Reticle stage 152 can be formed with a reticle masking blade defining a slit through which the excimer laser light is delivered from the light delivery unit 130 incident onto the patterned image. Reduction-projection lens 160, disposed between reticle 150 and waver W, reduces and projects the excimer laser light transferred through the patterned image of reticle 150 onto the photoresist formed on wafer W. Reduction-projection lens 160 may comprise, for example a housing that includes a plurality (e.g. 23) of combinations of convex and concave lenses spaced a distance apart. Each of the convex lenses converges parallel light traveling in one direction, and each concave lens diverges the parallel light. In this manner, reduction-projection lens 160 corresponds to one convex lens that reduces and projects the excimer laser light transferred to the patterned image. The resolution and the DOF can be determined by the NA of the convex lens and the NA can be adjusted by a medium and aperture of the convex lens.

The resolution of light increases in direct proportion to the wavelength of the excimer laser light in inverse proportion to the NA as shown by Equation 1 referenced above. Therefore, the wavelength of the excimer laser light should be shortened in order to lower its resolution. However, the DOF increases in direct proportion to the wavelength of the excimer laser light and in inversely to the square of the NA as shown by Equation 2 referenced above. For example, the DOF can be increased using excimer laser light having a wavelength of about 248.4 nm as compared to light having a wavelength of about 248.3 nm. Thus, when the wavelength of the excimer laser light increases, the DOF increases. Excimer laser 100 in accordance with one aspect of the present invention produces excimer laser light having a different plurality of single wavelengths which includes a greater wavelength range compared to conventional excimer laser light having a single wavelength such that the DOF and margin of the generated light is increased.

In accordance with one aspect of the present invention, excimer laser light having the different plurality of single wavelengths is produced and supplied to an exposure apparatus. The excimer light is reduced and projected through a reduction-projection lens of the exposure apparatus onto a photoresist. The DOF and margin of the light incident on the photoresist is increased making it possible to prevent exposure failures, thereby maximizing production yields.

The invention has been described in the context of several embodiments. However, it is to be understood that the scope of the invention is not limited to only the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A line-narrowing module of an excimer laser, comprising:
a beam expander disposed on a first side of an excimer laser light generator, said beam expander configured to pass laser light produced by and incident from said generator and collimating said laser light in one direction;
a diffraction grating disposed on a second side of said generator, said first side opposite from said second side, said grating configured to diffract the collimated laser light received from said beam expander such that a traveling direction of said laser light is separated according to a respective wavelength associated with said laser light; and
a multi-wavelength reflector disposed at a reflecting position between said diffraction grating and said beam expander, said multi-wavelength reflector configured to reflect said multi-wavelength laser light separated by said diffraction grating back to said generator through said beam expander.

2. The line-narrowing module according to claim 1, wherein the multi-wavelength laser light includes laser light having a different plurality of single wavelengths.

3. The line-narrowing module according to claim 1, wherein the multi-wavelength reflector comprises:
a mirror for reflecting said multi-wavelength laser light onto said beam expander; and
a vibrator for vibrating one side of said mirror in order to collect the laser light having a plurality of single wavelengths and different traveling directions varied by said mirror.

4. The line-narrowing module according to claim 3, wherein said vibrator comprises a piezo actuator.

5. The line-narrowing module according to claim 3, wherein said vibrator vibrates one side of said mirror at a frequency higher than an oscillating frequency supplied to said generator of said excimer laser.

6. The line-narrowing module according to claim 1, further comprising a first slit formed on one side of said beam expander provided with a first aperture defining a cross section of the laser light when the laser light incident from said generator to said beam expander passes through said first aperture.

7. The line-narrowing module according to claim 1, wherein said beam expander reduces a cross section associated with said multi-wavelength laser light reflected and incident from said multi-wavelength reflector such that an optical path of said multi-wavelength laser light is varied

8. The line-narrowing module according to claim 1, wherein said diffraction grating comprises an Echelete grating.

9. The line-narrowing module according to claim 1, wherein said diffraction grating comprises a Littrow grating.

10. An excimer laser comprising:
a generator exciting a light emitting material to produce laser light;
a line-narrowing module positioned on a first side of said generator, said line-narrowing module comprising:
a beam expander passing said laser light produced by and incident from said generator, said beam expander collimating said laser light in one direction;
a diffraction grating configured to receive said laser light collimated through said beam expander, said grating diffracting said laser light such that a traveling direction of said laser light is separated according to a wavelength associated with said laser light; and
a multi-wavelength reflector disposed between said diffraction grating and said beam expander toward a first side of said line-narrowing module, said multi-wavelength reflector reflecting said laser light having at least a different plurality of single wavelengths from the laser light whose traveling direction is separated by said diffraction grating onto said beam expander such that said laser light having a multi-wavelength re-enters said generator through said beam expander; and
an output coupler module 30 positioned on a second side of said generator opposite from said first, said coupler emitting said laser light re-entered into said generator externally from said laser.

11. The excimer laser according to claim 10, wherein said generator comprises:
a laser chamber filled with a light emitting material;
a voltage supply configured outside of said laser chamber, said voltage supply for providing supply voltage having a predetermined oscillating frequency;
a plurality of main electrodes disposed a predetermined distance apart and located at an upper end and a lower end of said laser chamber, said electrodes receiving supply voltage from said voltage supply and electrifying said light emitting material inside said laser chamber;
a fan formed within said chamber to circulate said light emitting material between said main electrodes at a constant flow rate;
a heat exchanger positioned below said fan for absorbing and cooling heat associated with said light emitting material;
a storage capacitor formed on a cable connected from said voltage supply to any one of said main electrodes;
a plurality of arc pins disposed around said main electrodes and along said cable, said arc pins discharging electricity induced in the proximity of said main electrodes in order to preliminarily ionize ultraviolet light from said light emitting material; and
peaking capacitors disposed between said arc pins and said storage capacitor, said peaking capacitors amplifying said supply voltage being charged or discharged by said storage capacitor.

12. The excimer laser according to claim 11, wherein said laser chamber comprises:
a first window formed on a first sidewall of said laser chamber for providing laser light, produced between said main electrodes by said light emitting material, to be incident onto said line-narrowing module; and
a second window formed on a second sidewall of said laser chamber for providing laser light to be incident onto said output coupler module.

13. The excimer laser according to claim 12, wherein
said first window passes all of the laser light having various wavelengths produced in said laser chamber through to said line-narrowing module; and
said second window reflects various wavelengths of all the laser light produced in said laser chamber onto said first window and selectively passes only laser light having the different plurality of single wavelengths split and extracted by said line-narrowing module.

14. The excimer laser according to claim 11, wherein said voltage supply comprising:
a pulse transformer for transforming primary high voltage into secondary high voltage having a predetermined frequency; and
a switch for switching the high voltages at the predetermined oscillating frequency so that the laser light is repetitively emitted from said light emitting material flowing between said main electrodes while the predetermined frequency of the secondary high voltage produced by said pulse transformer is charged or discharged in or from said storage capacitor.

15. The excimer laser according to claim 10, wherein said multi-wavelength reflector comprises:
a mirror for reflecting the multi-wavelength laser light onto said beam expander; and
a vibrator for vibrating one side of said mirror in order to collect the laser light having a plurality of single wavelengths and different traveling directions varied by said mirror.

16. The excimer laser according to claim 15, wherein said vibrator comprises a piezo actuator.

17. The excimer laser according to claim 15, wherein said vibrator vibrates one side of said mirror at a frequency higher than an oscillating frequency supplied to said generator of said excimer laser.

18. The excimer laser according to claim 10, wherein said line-narrowing module comprises a first slit formed on one side of said beam expander and a first aperture associated with said first slit defining a cross section of the laser light when the laser light incident from said generator to said beam expander passes therethrough.

19. The excimer laser according to claim 10, wherein said beam expander reduces a cross section of said multi-wavelength laser light reflected and incident from said multi-wavelength reflector, and varies an optical path associated with said multi-wavelength laser light.

20. The excimer laser according to claim 10, wherein the output coupler module includes a second slit that is formed with a second aperture defining a cross section of the laser light having the different plurality of single wavelengths, said second slit allowing said laser light having the different plurality of single wavelengths emitted through said generator from said line narrowing module to pass therethrough.

21. The excimer laser according to claim 19, wherein said output coupler module further comprises:
a wavelength detector for detecting said laser light having the different plurality of single wavelengths that passes through said second aperture; and
a wavelength controller for feeding back a detected signal detected by said wavelength detector to said line-narrowing module to allow said laser light having a corresponding one of the different plurality of single wavelengths to be selected by said line-narrowing module based on said detected signal.
